(19) United States
(12) Patent Application Publication
(10) Pub. No.: US 2026/0346357 A1
(43) Pub. Date: Nov. 5, 2026

(54) DYNAMIC INTERPASS COOLING IN DIRECT THERMAL DEPOSITION

(71) Applicant: AUBURN UNIVERSITY, Auburn, AL (US)

(72) Inventor: David Scott Neff, JR., Opelika, AL (US)

(21) Appl. No.: 19/659,934

(22) Filed: Apr. 27, 2026

Related U.S. Application Data
(60) Provisional application No. 63/796,755, filed on Apr. 29, 2025.

(51) Int. Cl. B23K 9/095; B23K 9/04; B23K 31/00; B33Y 50/02

(52) U.S. Cl. CPC B23K 9/0953; B23K 9/042; B23K 31/003; B33Y 50/02

(57) ABSTRACT

The subject matter of this specification can be embodied in, among other things, a system for managing interpass cooling during a direct energy deposition additive manufacturing process includes a processor, and a memory storing instructions that, when executed by the processor, cause the processor to perform operations including parsing a tool path program to extract print parameters and machine instructions for the direct energy deposition additive manufacturing process, generating a dynamic three dimensional thermal simulation of a print process based on the extracted print parameters, the machine instructions, and material properties, predicting an interpass temperature for a deposited layer based on the dynamic three dimensional thermal simulation, determining a dynamic pause time by comparing the predicted interpass temperature to a target interpass temperature, and modifying the tool path program to inject the dynamic pause time into the machine instructions prior to execution of the tool path program.

### CROSS REFERENCE TO RELATED APPLICATIONS

This application claims the benefit of priority to U.S. Provisional Patent Application No. 63/796,755, filed on Apr. 29, 2025, the entire contents of which are hereby incorporated by reference in their entirety.

### TECHNICAL FIELD

This instant specification relates to systems and methods for optimizing interpass cooling during a direct energy deposition additive manufacturing process.

### BACKGROUND

Additive manufacturing, including direct energy deposition and wire arc additive manufacturing (e.g., 3D printing using welding processes to deposit metal), provides an efficient alternative for producing large structural metal components due to rapid material deposition rates. During these processes, previously deposited layers are reheated by the addition of subsequent layers. The temperature of the part before the next layer is deposited, known as the interpass temperature, significantly affects the mechanical properties, structural integrity, and geometric tolerances of the final component. To manage residual heat buildup, manufacturers often rely on arbitrary pause times between layers, which can unnecessarily double or extend production times. Alternatively, some systems employ closed loop thermal monitoring systems that require the integration of expensive, complex hardware sensors, such as pyrometers or thermocouples, to dictate pause times. These hardware solutions are often not adopted by production level systems due to the additional expenses, calibration requirements, and high failure rates caused by placing sensitive imaging sensors and electronics in close proximity to the extreme heat, strong electromagnetic fields, and the smoke and flying debris that typically occurs during welding operations.

### SUMMARY

In general, this document describes systems, methods, and computer readable media for optimizing interpass cooling during a direct energy deposition additive manufacturing process.

In an example embodiment, a system for managing interpass cooling during a direct energy deposition additive manufacturing process includes a processor, and a memory storing instructions that, when executed by the processor, cause the processor to perform operations including parsing a tool path program to extract print parameters and machine instructions for the direct energy deposition additive manufacturing process, generating a dynamic three dimensional thermal simulation of a print process based on the extracted print parameters, the machine instructions, and material properties, predicting an interpass temperature for a deposited layer based on the dynamic three dimensional thermal simulation, determining a dynamic pause time by comparing the predicted interpass temperature to a target interpass temperature, and modifying the tool path program to inject the dynamic pause time into the machine instructions prior to execution of the tool path program.

Various embodiments can include some, all, or none of the following features. The instructions that cause the processor to generate the dynamic three dimensional thermal simulation can further cause the processor to generate a nodal mesh over a build volume and activate nodes within the nodal mesh using an element birth and death activation strategy based on the machine instructions. The instructions that cause the processor to generate the nodal mesh can further cause the processor to aggregate a collection of nodes located beyond a threshold distance from a heat source into an aggregated mass to reduce a computational burden of the dynamic three dimensional thermal simulation. The operations can further include constructing a heat input field using a double ellipsoid model, and applying the heat input field to the dynamic three dimensional thermal simulation. The operations can further include adjusting environmental parameters within the dynamic three dimensional thermal simulation to account for a forced flow cooling system. The operations can further include subdividing the deposited layer into a collection of thermal zones, predicting localized interpass temperatures for each thermal zone of the collection of thermal zones, and applying the dynamic pause time to a first thermal zone of the collection of thermal zones while permitting deposition in a second thermal zone of the collection of thermal zones.

In another example embodiment, a non-transitory computer readable storage medium having instructions stored thereon that, when executed by a processor, cause the processor to perform operations including parsing a tool path program to extract print parameters and machine instructions for a direct energy deposition additive manufacturing process, generating a dynamic three dimensional thermal simulation of a print process based on the extracted print parameters, the machine instructions, and material properties, predicting an interpass temperature for a deposited layer based on the dynamic three dimensional thermal simulation, determining a dynamic pause time by comparing the predicted interpass temperature to a target interpass temperature, and modifying the tool path program to inject the dynamic pause time into the machine instructions prior to execution of the tool path program.

Various embodiments can include some, all, or none of the following features. The instructions that cause the processor to generate the dynamic three dimensional thermal simulation can further cause the processor to generate a nodal mesh over a build volume and activate nodes within the nodal mesh using an element birth and death activation strategy based on the machine instructions. The instructions that cause the processor to generate the nodal mesh can further cause the processor to aggregate a collection of nodes located beyond a threshold distance from a heat source into an aggregated mass to reduce a computational burden of the dynamic three dimensional thermal simulation. The operations can further include constructing a heat input field using a double ellipsoid model, and applying the heat input field to the dynamic three dimensional thermal simulation. The operations can further include subdividing the deposited layer into a collection of thermal zones, predicting localized interpass temperatures for each thermal zone of the collection of thermal zones, and applying the dynamic pause time to a first thermal zone of the collection of thermal zones while permitting deposition in a second thermal zone of the collection of thermal zones.

In an example implementations, a computer implemented process for managing interpass cooling during a direct energy deposition additive manufacturing process, the method including parsing a tool path program to extract print parameters and machine instructions for the direct energy deposition additive manufacturing process, generating a dynamic three dimensional thermal simulation of a print process based on the extracted print parameters, the machine instructions, and material properties, predicting an interpass temperature for a deposited layer based on the dynamic three dimensional thermal simulation, determining a dynamic pause time by comparing the predicted interpass temperature to a target interpass temperature, and modifying the tool path program to inject the dynamic pause time into the machine instructions prior to execution of the tool path program.

Various implementations can include some, all, or none of the following features. Generating the dynamic three dimensional thermal simulation can include generating a nodal mesh over a build volume and activating nodes within the nodal mesh using an element birth and death activation strategy based on the machine instructions. Generating the nodal mesh can include aggregating a collection of nodes located beyond a threshold distance from a simulated deposition heat source into an aggregated mass to reduce a computational burden of the dynamic three dimensional thermal simulation. The process can further include determining a nominal bead height and a nominal bead width for the deposited layer using regression based equations that account for the material properties and one or more heat input effects.

The process can further include constructing a heat input field using a double ellipsoid model, and applying the heat input field to the dynamic three dimensional thermal simulation. The process can further include adjusting environmental parameters within the dynamic three dimensional thermal simulation to account for a forced flow cooling applied during the direct energy deposition additive manufacturing process. The tool path program can include machine instructions configured to control simultaneous operation of a collection of print heads, and wherein the dynamic three dimensional thermal simulation coordinates heat input from the collection of print heads.

The process can further include subdividing the deposited layer into a collection of thermal zones, predicting localized interpass temperatures for each thermal zone of the collection of thermal zones, and applying the dynamic pause time to a first thermal zone of the collection of thermal zones while permitting deposition in a second thermal zone of the collection of thermal zones. Modifying the tool path program to inject the dynamic pause time can be performed as a post processing step such that the modified tool path program is configured to be performed without reliance on real time sensor based feedback loops.

The systems and techniques described here may provide one or more of the following advantages. First, the system can provide improved metallurgical and geometric fidelity by proactively identifying and mitigating localized hot spots before they cause thermal warping or undesirable phase transformations. Second, the system can significantly reduce overall manufacturing time by calculating precise, localized cooling durations, thereby avoiding overly conservative, static pause times. Third, the system can operate as an offline post processing tool, which removes the reliance on expensive and delicate closed loop sensor networks, such as optical pyrometers, that frequently fail in harsh welding environments. Fourth, the system can generate highly portable modified build plans that can be executed directly by standard direct energy deposition machines without requiring hardware retrofits. Fifth, the system can efficiently resolve complex scenarios, such as coordinating heat inputs from multiple deposition heads simultaneously to prevent destructive thermal interference. Sixth, the system can substantially reduce computing time, memory utilization, and storage requirements associated with the computation of the pause times.

The details of one or more implementations are set forth in the accompanying drawings and the description below. Other features and advantages will be apparent from the description and drawings, and from the claims.

### DESCRIPTION OF DRAWINGS

FIG. 1 illustrates a block diagram of an exemplary system 100 for improving interpass cooling during a direct energy deposition additive manufacturing process.

FIG. 2 illustrates a flow diagram of an exemplary process for optimizing interpass cooling during an additive manufacturing process.

FIG. 3 illustrates a flow diagram of an exemplary process for calibrating thermal models utilized in an additive manufacturing simulation.

FIG. 4 illustrates a flow diagram of an exemplary process for generating a dynamic nodal mesh and executing a birth and death activation strategy during an additive manufacturing simulation.

FIG. 5 illustrates a schematic cross sectional view of a deposited weld bead 510 physically bonded to a substrate 520 during an additive manufacturing process.

FIG. 6 illustrates a conceptual schematic cross sectional view of a direct energy deposition environment 600 during an active deposition event.

FIG. 7 illustrates a conceptual schematic perspective view of a direct energy deposition environment during an active virtual simulation.

FIG. 8 illustrates a flow diagram of an exemplary process for modifying a direct energy deposition build plan.

FIG. 9 is a schematic diagram that shows an example of a computing system that can be used to implement the techniques described herein.

### DETAILED DESCRIPTION

This document describes systems and techniques for managing interpass cooling during a direct energy deposition (DED) additive manufacturing process by utilizing a dynamic three-dimensional thermal simulation to predict cooling requirements and automatically modify a tool path program with dynamic pause times. The system improves computational efficiency by aggregating nodes located beyond a threshold distance from a simulated heat source into an aggregated mass and utilizes a birth and death element activation strategy to represent the physical sequence of material deposition. In general, the system functions as a post-processing tool that extracts print parameters from a standard build plan, simulates a build, performs a transient thermal analysis of the simulated build to identify any sub-portions of the build process that could lead to over-temperature conditions within material deposited during the build process, and rewrites the machine instructions with specific dwell commands to reduce or prevent over-temperature conditions from occurring within material as it is deposited during a build process based on the rewritten machine instructions. The system can utilize these rewritten instructions to facilitate a target interpass temperature being achieved across multiple thermal zones.

Managing localized hot spots during a direct energy deposition process is important for maintaining the structural integrity and geometric accuracy of the printed component. A hot spot can develop when a deposition head dwells too long in a specific area or returns to a recently deposited region before sufficient cooling has occurred. These hot spots often lead to non-uniform thermal expansion and subsequent contraction, which introduces significant internal residual stresses into the part. Such stresses can result in macroscopic warping, where the part physically pulls away from the build plate or distorts out of the required dimensional tolerances. Additionally, excessive heat can fundamentally alter the metallurgical properties of the material, leading to undesirable grain growth or the formation of brittle phases that compromise the overall fatigue life and tensile strength of the component. By utilizing the dynamic thermal simulation to identify these potential hot spots before the physical build begins, the system can proactively implement cooling pauses to promote consistent material properties and high fidelity results.

As they are used in this document, the terms “optimize” and “optimization” are not limited to ideal or perfect results, or to operations that are configured to provide ideal or perfect results. These terms also include improved, albeit imperfect, results, and processes that work toward an idealized objective without necessarily fully achieving such objectives (e.g., an “optimization” process can be a process of partial improvement that is not limited to absolute perfection).

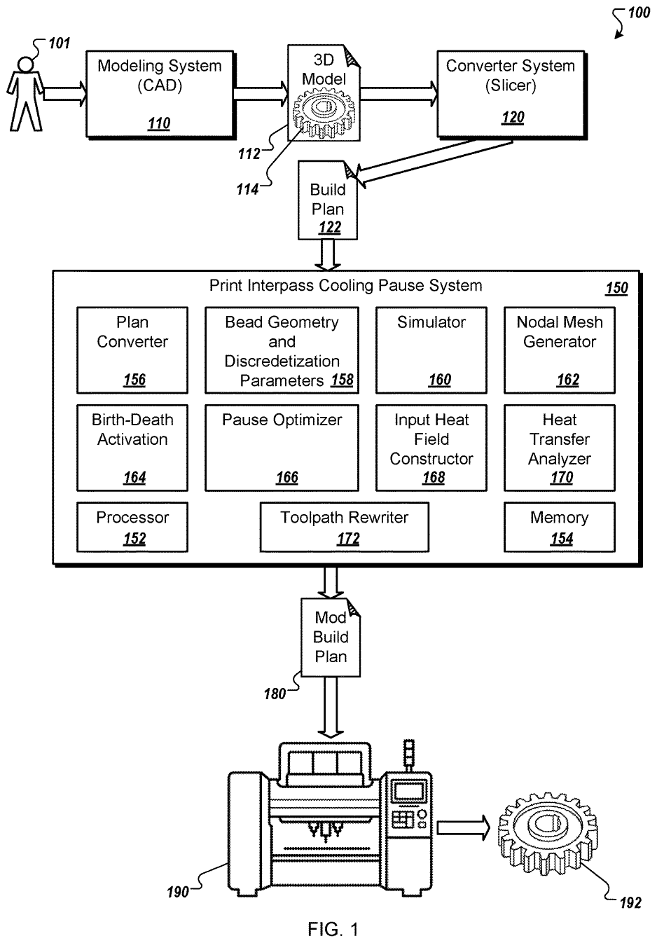

FIG. 1 illustrates a block diagram of an exemplary system 100 for improving interpass cooling during a direct energy deposition additive manufacturing process, in accordance with some implementations of the present disclosure. The system 100 demonstrates the end-to-end computational workflow from initial part design to the physical deposition of a component. In particular, the system 100 highlights a print interpass cooling pause system 150 that functions as a post-processing toolpath optimizer, bridging the gap between conventional slicing software and the physical manufacturing hardware.

In the illustrated system 100, a user 101 may interact with a modeling system 110, such as a Computer-Aided Design (CAD) system, a 3D modeling application, or a generative design platform, to generate a three-dimensional (3D) model 112 representing a desired geometric component 114. The 3D model 112 can be formatted as a stereolithography (STL) file, an Additive Manufacturing File (AMF), a 3D Manufacturing Format (3MF) file, or any other suitable geometric representation. The 3D model 112 is provided to a converter system 120, which may include slicer software configured to mathematically slice the 3D model 112 into discrete planar layers and translate the sliced model into a build plan 122. The build plan 122 generally includes a tool path program, such as standard numerical control programming language or G-code, that can include print parameters and machine instructions intended to direct the spatial movements, travel speeds, and material deposition rates of an additive manufacturing system.

To proactively manage residual heat buildup without relying on arbitrary wait times or complex closed-loop hardware sensors, the build plan 122 is routed to the print interpass cooling pause system 150 prior to execution. Left unmanaged, excessive interpass temperatures can cause severe metallurgical issues, including warped features, inconsistent microstructures, degraded yield strength, and total build failures. Conversely, arbitrary fixed pause times often extend manufacturing schedules by hours or days unnecessarily. The print interpass cooling pause system 150 is configured to address these issues. The system 150 can include one or more computing devices, such as a local desktop computer, a distributed cloud computing cluster, or an edge device, having at least one processor 152 and a memory 154 storing executable instructions that, when executed, cause the processor 152 to perform dynamic finite element thermal simulations and intelligent toolpath modifications.

The print interpass cooling pause system 150 can include a plan converter 156 configured to parse the tool path program of the build plan 122 to sequentially extract the print parameters and machine instructions for the direct energy deposition process. In some implementations, this parsing operation can involve differentiating between active deposition commands, such as where a laser or arc is active and material is extruded, and rapid transit commands, such as movement between deposition zones where no heat is introduced. Additionally, in some implementations, the build plan 122 can include instructions for multiple deposition heads, such as for a direct energy deposition system that can print with multiple heads at the same time. The extracted parameters can include, but are not limited to, spatial coordinates, tool travel speeds, wire feed rates, and localized heat source power inputs for each of the one or more deposition heads.

A bead geometry and discretization parameters module 158 is configured to utilize the extracted data to determine a nominal bead height and a nominal bead width for each deposited layer. Accurately predicting the physical geometry of the melt pool is important for simulation accuracy because this geometry directly impacts thermal mass and heat conduction. In some implementations, the nominal bead dimensions may be calculated using regression-based equations or machine learning models that account for specific material properties, including thermal conductivity or specific heat capacity of titanium, steel, or aluminum alloys, and heat input effects such as laser power, travel speed, and shield gas flow.

Based on these geometry parameters and the parsed machine instructions, a simulator 160 is configured to generate a dynamic three-dimensional thermal simulation of the entire print process. The simulator 160 serves as a transient thermal solver capable of modeling the complex thermal gradients that evolve rapidly over time as thousands of individual weld beads are stacked to form the physical component.

In supporting the simulator 160, a nodal mesh generator 162 can generate a multi-resolution nodal mesh over a simulated build volume, which includes both the component being built and the underlying build plate. To reduce the computational burden, the nodal mesh generator 162 may dynamically adjust the mesh density, maintaining a high-resolution, dense grid of finite elements near the active heat source while aggressively aggregating and coarsening elements located beyond a threshold distance into a larger vestigial mass.

A birth-death activation module 164 can activate nodes within the generated nodal mesh using an element birth and death activation strategy based on the parsed machine instructions. Prior to the simulated print head reaching a specific coordinate, the finite elements representing the material at that coordinate mathematically exist within the matrix but are assigned near-zero stiffness and conductivity values. As the machine instructions dictate that material is deposited at that location, the corresponding elements are born or activated with the true physical and thermal properties of the deposited material, physically and dynamically representing the sequence of material deposition over time.

Furthermore, an input heat field constructor 168 can construct a volumetric heat input field, such as a double ellipsoid model, and apply the heat input field to the active nodes in the dynamic three-dimensional thermal simulation. The double ellipsoid model is uniquely suited for direct energy deposition, as it accurately distributes the simulated heat flux into a shallower, steeper front half and a longer, trailing back half to simulate the physical dynamics of a moving melt pool.

As the simulation progresses chronologically through the tool path, a heat transfer analyzer 170 can continually predict an interpass temperature for a currently deposited layer or a subsequent layer based on the dynamic three-dimensional thermal simulation. The heat transfer analyzer 170 evaluates not only the conductive heat transfer through the previously deposited solid material and the build plate, but can also incorporate boundary conditions reflecting convective cooling and radiative heat loss to the ambient environment. In some implementations, the heat transfer analyzer 170 can adjust these environmental parameters to account for specialized manufacturing setups, such as forced flow cooling systems or inert gas shielding. In some implementations, the heat transfer analyzer 170 can be configured to account for the effects and locations of heat sources other than the work tool, such as an externally-heated build plate or a thermostatically-controlled build environment (e.g., such as those commonly used in additive manufacturing of materials such as thermoplastics).

A pause optimizer 166 can then evaluate these transient thermal predictions, determining a required dynamic pause time by comparing the predicted interpass temperature to a predefined target interpass temperature. If the predicted temperature of the substrate layer exceeds the maximum allowable threshold for the specific metal alloy being printed, the pause optimizer 166 calculates the precise duration of time required for the part to radiatively and convectively cool to the target interpass temperature. In some embodiments, the pause optimizer 166 can subdivide the deposited layer into multiple distinct thermal zones, applying a calculated dynamic pause time to a first thermal zone that is too hot, while simultaneously permitting continuous deposition in a second thermal zone that has sufficiently cooled.

Once the dynamic pause times are calculated to facilitate optimal thermal conditions between layers or thermal zones, a toolpath rewriter 172 modifies the original tool path program. Specifically, the toolpath rewriter 172 logically injects the dynamic pause time into the machine instructions of the build plan 122. This can be achieved by inserting specific dwell commands with the calculated duration immediately preceding the deposition instructions for the overheated layer, outputting a complete, modified build plan 180.

Because the modifying of the tool path program to inject the dynamic pause time is performed entirely as an upfront computational post-processing step within the print interpass cooling pause system 150, a direct energy deposition system 190 can receive and execute the modified build plan 180 directly. The direct energy deposition system 190 deposits material to form a physical component 192 possessing improved mechanical properties, more uniform grain structures, and/or tighter geometric tolerances (as compared to similar components manufactured using the unmodified build plan 122). As such, the direct energy deposition system 190 can execute the thermally improved instructions without requiring the integration of expensive, fragile pyrometers or relying on complex, real-time sensor-based feedback loops to arrest the print process.

While the present techniques are described primarily in the context of direct energy deposition printing of metal alloys, it should be understood that these methods and systems can be used with any other appropriate form of additive manufacturing that involves heating or thermal management. This can include, for example, conventional 3D printing of plastics or polymers, such as fused deposition modeling or fused filament fabrication. In such implementations, the dynamic thermal simulation can be configured to model the glass transition temperatures and cooling rates of various thermoplastic materials to prevent warping or poor layer adhesion. By predicting and managing the thermal history of a part during the build process, the system can improve consistent quality across different material types and printing technologies.

Furthermore, because the direct energy deposition system 190 does not require any specialized thermal monitoring hardware, given that all of the precise timing modifications are statically coded directly into the modified build plan 180, the modified build plan 180 is highly portable. The modified build plan 180 can be distributed to and executed by multiple other direct energy deposition systems that are similarly unmodified standard machines. In other words, the computationally intensive simulation and toolpath generation can be executed once, and the resulting modified build plan 180 can be used repeatedly across a fleet of machines, potentially simultaneously in disparate geographic locations. This allows for scaled production without incurring additional upfront computational processing time for each print and without the prohibitive expense of retrofitting multiple systems with complex closed-loop sensor suites.

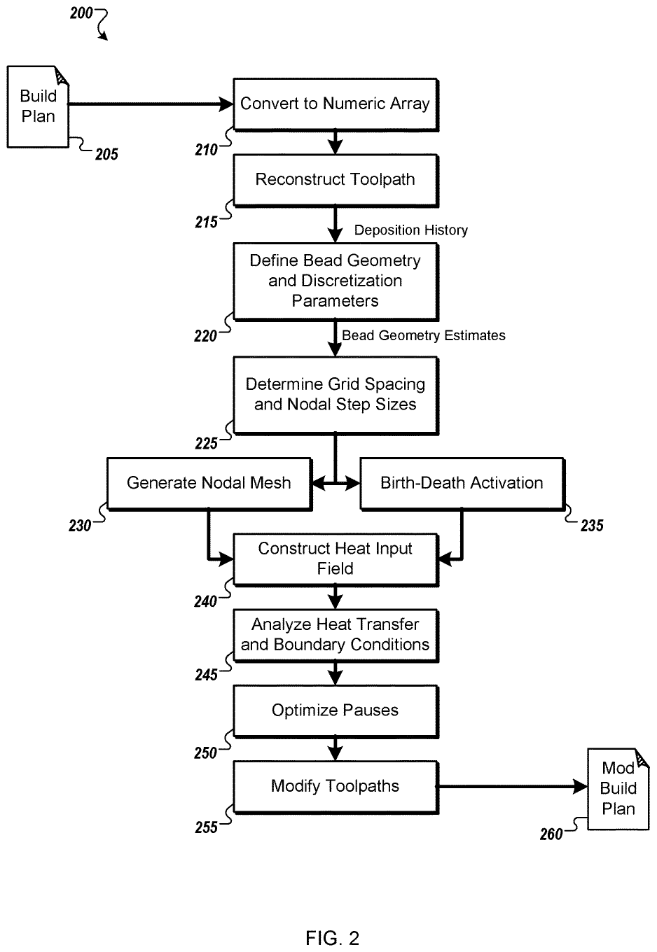

FIGS. 2, 3, 4, and 8 are flow charts that show examples of processes for print interpass colling pause processing. The processes may be performed, for example, by a system such as the example system 150 of FIG. 1. For clarity of presentation, the descriptions that follow uses the system 100 as an example for describing the processes. However, another system, or combination of systems, may be used to perform the processes.

FIG. 2 illustrates a flow diagram of an exemplary process 200 for optimizing interpass cooling during an additive manufacturing process. In some implementations, the operations of the process 200 can be executed by the example print interpass cooling pause system 150 of FIG. 1, functioning as a software engine to process and modify a build plan prior to physical execution.

In general, the process 200 provides a detailed computational workflow, which can be implemented as a Print Interpass Cooling Pause Optimization (PICPO) framework, developed to evaluate and reduce interpass cooling delays in direct energy deposition processes, including wire arc additive manufacturing. Additive manufacturing processes that utilize direct energy deposition, particularly those depositing large volumes of metal wire via electric arcs, introduce massive amounts of thermal energy into the substrate. Because each successive layer is welded directly onto the preceding layer, heat can accumulate rapidly within the physical component. If this thermal accumulation is left unmanaged, the localized substrate can reach elevated temperatures that can severely degrade the mechanical stability of the melt pool, causing the deposition geometry to slump, wander, and/or collapse entirely. Furthermore, extreme interpass temperatures can induce undesirable microstructural phase transformations, increase the width of the heat-affected zone, and/or lock severe residual stresses into the part upon final cooling. The framework operates by converting toolpaths, such as wire arc additive manufacturing G-code toolpaths, into transient three-dimensional thermal simulations to combat these specific metallurgical and geometric challenges. These simulations are then used to assess interpass temperature evolution and identify opportunities to reduce dwell time without exceeding predefined thermal limits. By digitally simulating the physical addition of material and the corresponding heat flux over time, the print interpass cooling pause system 150 can identify specific locations within the build volume where the substrate temperature is predicted to exceed a target threshold.

The process 200 and the associated framework were developed specifically to address the reliance on fixed or arbitrarily selected interpass pause durations commonly used in direct energy deposition processes. Historically, machine operators have mitigated heat buildup by programming static, universally applied dwell times between every layer, which often extends the total manufacturing time by hours or days unnecessarily. Alternatively, closed-loop systems attempt to monitor temperatures using infrared cameras or pyrometers, but these delicate hardware components frequently fail or report inaccurate data due to the intense ultraviolet radiation, smoke, and flying metallic spatter inherent to the welding environment. Rather than requiring additional hardware or closed-loop machine control, the framework operates as a purely deterministic post-processing tool that evaluates existing toolpaths prior to fabrication. The process 200 automatically calculates the precise duration of time needed for the material to cool to an acceptable level based on the fundamental laws of thermodynamics and heat transfer. The resulting pause recommendations and corresponding dwell commands are incorporated directly into machine code, allowing the approach to be applied to production style equipment without modifying the underlying motion or deposition systems. This predictive computational approach allows manufacturers to improve part quality and mitigate thermal distortion without relying on physical trial and error iterations or expensive real time sensory hardware.

The process 200 begins when a build plan 205 is received, which in some implementations can be the build plan 122 of FIG. 1. The build plan 205 acts as the foundational set of instructions for the physical manufacturing hardware, such as a wire arc additive manufacturing G-code file. At 210, the plan converter 156 reads the build plan and converts the program into a numeric array representation suitable for downstream processing. Standard additive manufacturing toolpaths are typically written in alphanumeric programming languages, such as G-code, which are highly inefficient for complex thermal simulations. Reading and parsing string-based alphanumeric characters line by line and performing a computationally intensive thermal calculation loop in real time during a physical build process would introduce severe latency. As such, the process 200 post-processes the G-code “offline” and substantially or entirely prior to build time.

At 210, the software parses the alphanumeric machine code and converts it into a structured, highly optimized numeric array. This conversion extracts specific print parameters and categorizes each line of machine instruction, differentiating between active deposition movements, rapid non-printing transits, and/or customized machine commands. The numeric array can structure the data in computer memory, mapping variables such as target spatial coordinates, wire feed rates, tool travel speeds, and/or arc activation states into distinct mathematical arrangements for rapid, localized retrieval by the central processing unit.

At 215, the software utilizes the numeric array to reconstruct the toolpath. This operation transforms the parsed code into a time-resolved deposition history using a toolpath reconstruction routine. Because standard G-code provides spatial target endpoints and programmed travel speeds but lacks explicit chronological time values, this routine mathematically builds a consolidated record of commanded position, time, deposition state, travel speed, weld status, and/or corresponding program line indices. In some implementations, the process 200 can apply kinematic equations to determine the exact duration required to complete each movement vector, taking into account the specified acceleration and deceleration profiles of the printing hardware. This representation can establish the chronological and spatial sequence of deposition events used throughout subsequent modeling stages, creating a comprehensive spatiotemporal map of the entire print process from the first layer to the final layer. The deposition history can track the anticipated coordinates, travel speeds, and activation states of the print head at any given millisecond of the simulated build process, establishing a virtual clock that substantially synchronizes the thermal solver with the physical deposition sequence.

With the toolpath reconstructed, bead geometry and discretization parameters are defined at 220 to support nodal grid generation and deposition mapping. In some implementations, these operations can be executed by the example bead geometry and discretization parameters module 158. This operation can predict the physical, volumetric shape of the material being deposited. In some implementations, the system can improve the accuracy of these predictions by moving beyond basic bead geometry relationships. For example, Suryakumar relationships may lack sufficient sensitivity to material properties and heat input effects. Basic models often assume an idealized parabolic shape that fails to capture the fluid dynamics and surface tension behaviors of specific molten alloys. Instead, the process 200 can utilize a set of replacement equations developed using rigorous regression-based analysis to produce more accurate bead geometry estimates. These regression models are built by physically depositing test beads while varying input parameters, such as wire feed speed, travel speed, and arc power, and then measuring the resulting physical bead width and penetration depth

An example of such a second order regression structure that accounts for volumetric material deposition, travel speed, heat flux, and material specific properties such as thermal diffusivity for bead height is as follows:

h=c₁\dot{V}²+c₂TS²+c₃\dot{Q}²+c₄α²+c₅\dot{V}TS+c₆\dot{V}\dot{Q}+c₇\dot{V}α+c₈TS\dot{Q}+c₉TSα+c₁₀\dot{Q}α+c₁₁\dot{V}+c₁₂TS+c₁₃\dot{Q}+c₁₄α+c₁₅

Similarly, for width an equation could read:

w=c₁\dot{V}²+c₂TS²+c₃\dot{Q}²+c₄Hₘ²+c₅\dot{V}TS+c₆\dot{V}\dot{Q}+c₇\dot{V}Hₘ+c₈TS\dot{Q}+c₉TSHₘ+c₁₀\dot{Q}Hₘ+c₁₁\dot{V}+c₁₂TS+c₁₃\dot{Q}+c₁₄Hₘ+c₁₅
where: h is the resultant bead height, c₁-c₁₅ are constants determined through regression analysis (distinct values that vary between the two equations based on regression), \dot{V} is the volumetric flow rate, TS is the travel speed of the deposition instrument, \dot{Q} is the heat flux into the material from the deposition heat source, a is the thermal diffusivity of the material, w is the resultant bead width, and Hₘ is a material specific term used to represent the energy required to melt a control volume. Alternative material specific constraints may also be applied in place of thermal diffusivity or Hₘ, or specific variables may be removed if constants are found to be so reduced that they are negligible. Hₘ, while material specific, can be easily expressed using basic material properties and expressed as follows:

Hₘ=ρ(cₚ(T_{Liq}−T_{∞})+L_{F})
where: ρ is the material density, cₚ is the specific heat of the material, T_{Liq} is the fully liquidous temperature of the material, T_{∞} is the ambient temperature, and L_{F} is the latent heat of fusion.

These bead geometry estimates can be used to set a nominal grid spacing coefficient. Subsequent nodal partitioning can determine exact nodal step sizes as fractions of the nominal bead height, such as a z-step, and/or nominal bead width, such as an x-step or y-step. These calculations can account for specific material properties and heat input effects, accommodating the wider and deeper melt pools that result from higher power or slower travel speeds.

Using the bead geometry estimates, at 225 grid spacing and nodal increments are determined for the simulation environment. To accurately model heat conduction according to Fourier's law, the virtual environment can be discretized appropriately into a finite element mesh. For example, if the grid nodes are too far apart, the simulation may fail to capture the steep and rapid thermal gradients that occur immediately adjacent to the moving melt pool, resulting in artificially smeared and inaccurate temperature predictions. Conversely, if the grid nodes are excessively close together, the computational cost can increase exponentially, rendering the simulation impractical for large industrial components. At 225, the software calculates the optimal physical distance between finite element nodes based on the predicted bead dimensions to strike a balance between high-resolution accuracy and computational speed. Typically, the process 200 can use multiple nodes to span the width of a single predicted bead to adequately resolve the localized heat flux, while allowing for coarser spacing in regions far removed from the active welding zone.

Following the discretization calculations, the process 200 branches into two highly coordinated operations: at 230 a nodal mesh is generated and at 235 birth and death activation is performed. At 230, the nodal mesh generator 162 creates a three dimensional nodal grid over the build volume and build plate using discretization settings and bounding limits derived from the toolpath. The bounding limits define a virtual envelope that completely encapsulates the planned component. Nodes associated with the build plate are activated at an initialization stage, representing the massive thermal sink provided by the thick steel or aluminum baseplate used in the physical print environment. To minimize processing time, the process 200 can aggregate multiple nodes located beyond a threshold distance from the simulated heat source into a single aggregated mass.

Concurrently or sequentially, at 235, the birth and death activation module 164 executes an element birth and death activation strategy based on the derived deposition sequence. Deposition material is introduced using this strategy, and deposition mapping assigns occupancy and activation order within the grid through a deposition routine that tracks placement sequence, local fill fraction, and/or deposition impacts for later use in heat input construction and heat transfer analysis. Rather than continually restructuring the mathematical matrices at every time step to add new nodes, which is computationally prohibitive, the process 200 can initialize the finite elements representing the entire final component at the beginning of the simulation. However, the process 200 can initially assign near-zero stiffness and thermal conductivity multipliers to nodes representing unprinted material. By scaling the thermal conductivity of these unborn nodes by an infinitesimally small fraction, the unborn material can be substantially isolated and prevented from participating in the heat transfer equations. As the simulated print head passes over a specific coordinate driven by the virtual clock, those associated nodes are activated or born, and their actual thermophysical properties can be mathematically restored to the matrix, accurately mimicking the physical addition of hot metal.

At 240, the input heat field constructor 168 constructs a volumetric heat input field to simulate the thermal energy provided by the physical print head. In some implementations, the software applies a double ellipsoid model, such as a Goldak heat source model, mapping the expected thermal energy into a specific volumetric shape. This model can utilize two distinct semi-ellipsoids to represent the heat source, with a front semi-ellipsoid representing the leading edge of the melt pool and a rear semi-ellipsoid representing the trailing edge. This asymmetric shape can be used because a moving heat source inherently compresses the thermal gradient in the direction of travel while leaving a long, tapered thermal tail in its wake as the molten metal slowly solidifies. The heat flux distribution q(x, y, z) within these regions can be defined by equations that account for the arc power P, the thermal efficiency n, and geometric semi-axes a, b, c_{f}, and cᵣ.

For example, the heat flux in the front semi-ellipsoid can be expressed as:

$$q ( x , y , z ) = \frac{6 \sqrt{3} {q}_{f} η P}{a b {c}_{f} π \sqrt{π}} exp ( - \frac{3 {x}^{2}}{{a}^{2}} - \frac{3 {y}^{2}}{{b}^{2}} - \frac{3 {z}^{2}}{{c}_{f}^{2}} )$$

Similarly, the heat flux in the rear semi-ellipsoid can be expressed as:

$$q ( x , y , z ) = \frac{6 \sqrt{3} {q}_{r} η P}{a b {c}_{r} π \sqrt{π}} exp ( - \frac{3 {x}^{2}}{{a}^{2}} - \frac{3 {y}^{2}}{{b}^{2}} - \frac{3 {z}^{2}}{{c}_{r}^{2}} )$$

where: q_{f} and qᵣ represent the energy fractions at the front and rear of the double ellipsoid; v is the deposition speed; t is the time; a is the molten pool depth; b is the molten pool width; c_{f} and cᵣ are correlated with the dimensions of the front and rear double ellipsoid semi-axes; η is the thermal efficiency (e.g., 0.85 for cold metal transfer); P is the average instantaneous power; and x, y, and z are the locations of the nodes relative to the current position.

This heat input field can be applied directly to the activated nodes in the dynamic three dimensional thermal simulation to precisely model the localized heat flux and its interaction with the substrate material. In addition to spatial distribution, the process 200 can determine an energy-per-deposition quantity from average instantaneous power and the thermal efficiency factor, which is used to apply heat input during weld-active intervals. The thermal efficiency factor is particularly important, as a significant portion of the electrical energy generated by the power supply can be lost to the surrounding environment through arc radiation, spatter, and/or conduction through the welding torch components, rather than being transferred directly into the workpiece. While a and b can be easily identified based on post-mortem bead width and bead height observations, the c_{f} and cᵣ variables may be calibrated based on experimental observation using sacrificial test coupons.

As the virtual thermal energy is injected into the model, heat transfer and boundary conditions are analyzed at 245 to compute transient temperature evolution. The heat transfer analyzer 170 can operate as a transient thermal solver, utilizing a nodal heat transfer analysis routine applied to the activated solid domain. This routine can utilize the precomputed heat input field and deposition history as primary inputs. The solver can be executed with configurable settings that control radiation inclusion, adiabatic evaluation, transient property handling, convection formulation, timestep subdivision, optimization settings, and/or recording frequency. Boundary condition behavior can be managed through these solver settings and the geometric state of the evolving solid, including exposed surface area changes as deposition progresses. As new elements are born into the active simulation domain, the process 200 can continuously recalculate the exterior boundary of the part to properly apply convective and radiative cooling losses to the ambient air.

The transient heat transfer solution can be implemented using a fully implicit three dimensional formulation. A fully implicit solver algorithm can provide unconditional numerical stability, allowing the software to take larger time steps during long cooling periods without causing mathematical divergence or oscillatory failures. However, in some implementations, heat transfer in metal additive manufacturing can be highly non-linear. The thermal conductivity and specific heat capacity of metal alloys can change drastically across different temperature ranges, and radiative cooling can scale with the fourth power of the absolute surface temperature. Therefore, at each time substep, temperature-dependent terms, such as conductivity, heat capacity, and/or radiation or convection contributions, can be linearized about the current temperature estimate. This linearization can produces a large, sparse linear system of equations for that specific iteration. The coefficient matrix can be assembled from the transient mass term, boundary conductances, and/or conduction couplings between adjacent elements.

The process 200 then solves this system iteratively using a preconditioned conjugate gradient (PCG) method with a diagonal preconditioner. In some implementations, the PCG algorithm can be optimized for solving large, sparse, symmetric positive-definite matrices generated by finite element methods, processing the calculations much faster than traditional direct inversion techniques. In some implementations, if the PCG method does not converge within a specified tolerance or number of iterations due to severe local non-linearities, the solver can fall back to a direct linear solve to help promote mathematical resolution. The resultant temperature field can be updated and the temperature dependent terms can be interpolated between the initial and final temperature values. This process can repeat until the change between successive iterates is below a highly restricted convergence threshold, yielding the implicit solution for that time step. Through this analysis, the process 200 can predict an interpass temperature for substantially each deposited layer and/or for multiple distinct thermal zones within a single layer.

At 250, the pause optimizer 166 performs pause optimization using a user-defined temperature setpoint. When enabled, this optimization can modify the evaluation of pause durations within the nodal heat transfer analysis framework. Instead of strictly following the temporal commands of the original toolpath, the nodal heat transfer analysis subroutine can execute pause periods until the predicted temperature reaches the setpoint threshold instead of for a fixed duration. The pause optimizer 166 can evaluate programmed pauses identified in the source G-code, compute adjusted pause durations consistent with the setpoint criteria, and/or can summarize changes relative to the original dwell times. If the process 200 determines that a subsequent layer will be deposited while the substrate material is still too hot, it can determine a dynamic pause time to facilitate more favorable metallurgical properties and/or improve resistance to thermal distortion. To accomplish this, the solver can initiate a cooling loop, marching time forward without applying the volumetric heat input, simulating the print head idling in a resting position. The optimizer can periodically or continuously monitor the temperature of the underlying substrate nodes. Once the conductive and radiative losses pull the substrate temperature down to the targeted threshold, the optimizer can record the elapsed cooling duration and can terminate the dynamic pause calculation.

At 255, the toolpath rewriter 172 modifies the toolpaths to enact the simulated findings. If optimization is enabled and necessary thermal pauses are detected, the process 200 can rewrite the original machine instructions, such as the original G-code, by replacing existing arbitrary pause values with the precise predetermined pause durations. In some implementations, such modification can also include injecting entirely new dwell commands into the alphanumeric sequence where necessary to satisfy the setpoint criteria. For example, the process 200 can identify the programmatic index preceding a high-heat deposition sequence and insert a customized dwell code, explicitly commanding the robotic arm or CNC gantry to hold its position for the calculated number of seconds. The process 200 can logically inject the calculated dynamic pause times directly into the toolpath sequence, recalculate subsequent timestamp data to maintain file integrity, and/or save a revised toolpath file. This file, which can include an identifying tag to differentiate it from the unoptimized source file, can be generated as a modified build plan 260. The modified build plan 260 can then be deployed to a physical direct energy deposition system (e.g., the direct energy deposition system 190, to produce the physical component), operating with improved thermal management protocols and high geometric fidelity without any need for complex real-time sensor feedback or hardware modifications.

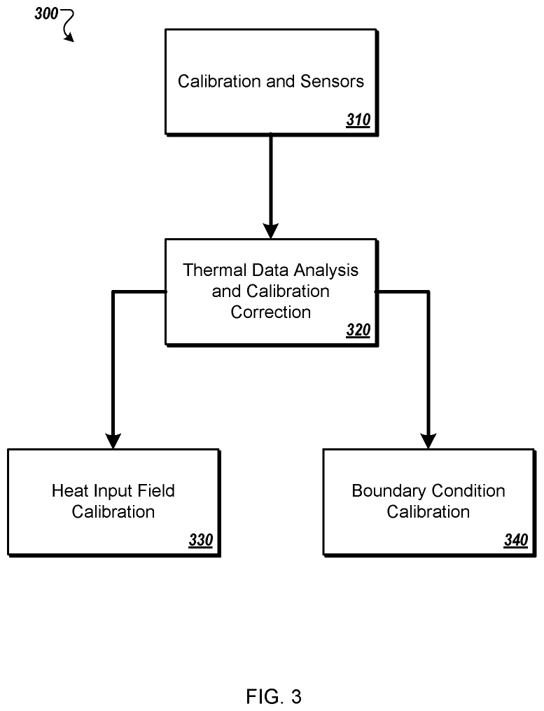

FIG. 3 illustrates a flow diagram of an exemplary process 300 for calibrating thermal models utilized in an additive manufacturing simulation. In some implementations, the operations of the process 300 can be executed to determine and refine the empirical variables used by the print interpass cooling pause system 150 of FIG. 1. The process 300 acts as a setup phase that provides the parameters used for the computational workflow described in the process 200 of FIG. 2, by supplying calibrated values for the heat input field construction and the boundary condition analysis.

Because the Print Interpass Cooling Pause Optimization (PICPO) framework relies on accurate transient thermal simulations to predict interpass temperatures, the underlying mathematical models are configured to closely reflect the physical realities of the specific printing hardware, the specific metal alloy being deposited, and the ambient environment of the manufacturing facility. The process 300 provides a systematic approach to aligning the virtual simulation with real-world thermodynamic behavior.

At 310, calibration and sensors are utilized to gather empirical thermal data from a physical test build. In some implementations, a machine operator can print a sacrificial test coupon, such as a single-walled linear geometry or a multi-layer block, using the specific direct energy deposition hardware and the specific material intended for the final production component. During this test print, physical sensors capture a localized temperature history. In some embodiments, these sensors can include K-type thermocouples physically welded to the build plate or embedded within the substrate, infrared cameras or other devices configured to capture thermal imagery of the surface temperature, and/or optical pyrometers focused on the melt pool. In some implementations, the infrared cameras can utilize specific wavelength filters to bypass the intense light and plasma glare generated by the welding arc, allowing for clear visualization of the localized thermal gradients across the substrate surface. Optical pyrometers, such as two color pyrometers, can be utilized to measure the extreme peak temperatures directly within the liquid metal of the active melt pool without requiring physical contact. The sensors and thermal imagery can be configured to periodically or continuously record the dynamic thermal environment, capturing the rapid, steep heating spike as the arc passes over a given coordinate. Following this rapid heating event, the hardware can record the subsequent non-linear cooling curves as the thermal energy dissipates into the surrounding environment and the underlying build plate. These cooling curves typically exhibit a rapid initial temperature drop driven by high thermal gradients and conduction, followed by a slower, gradual cooling tail dominated by convective and radiative heat losses. This comprehensive empirical data can provide a robust ground truth representation of the thermal dynamics for the specific machine and material combination. By establishing this physical baseline, the system can accurately account for real world variables that are difficult to predict theoretically, such as the cooling effects of specific shielding gas flow rates, thermal energy lost to spatter, and/or the unique thermal mass characteristics of the physical build plate and clamping fixtures.

With the physical sensor data collected, at 320 thermal data analysis and calibration correction are performed. A processing module can ingest the empirical data and compare it against a baseline simulation of the identical test coupon. The analysis can involve mapping the physical sensor locations to the corresponding finite element nodes within the virtual simulation and plotting the predicted time temperature history against the actual measured time temperature history. If the process 300 detects significant divergence between the simulated cooling curves and the physical cooling curves, calibration correction routines can be triggered. These routines can utilize iterative mathematical solvers to minimize the error between the predicted and observed temperatures. This error minimization process branches into two distinct but related calibration pathways to adjust the simulation variables: a heat input field calibration at 330 and a boundary condition calibration at 340.

At 330, heat input field calibration is executed to refine the volumetric distribution of thermal energy entering the model. In some implementations, this operation can directly inform the input heat field constructor 168 described in FIG. 1 and/or the heat input field construction at 240 in FIG. 2. For a double ellipsoid model, such as a Goldak heat source model, the process 300 can determine accurate values for the geometric semi-axes and the overall thermal efficiency. While the nominal bead width and depth can provide initial estimates for the transverse and vertical dimensions of the simulated melt pool, the thermal efficiency and the longitudinal thermal tail can be highly variable. At 330, the process 300 can iteratively adjust the thermal efficiency variable to match the peak temperatures recorded by the physical sensors. Concurrently, the process 300 can calibrate the rear semi-axis variable of the double ellipsoid model to accurately represent the elongated thermal gradient that trails behind the moving deposition head. By adjusting these variables until the simulated peak temperatures and immediate post deposition cooling rates match the empirical data, the system can generate a highly accurate representation of the energy transferred from the physical arc into the substrate.

Simultaneously or sequentially, at 340 boundary condition calibration is conducted to refine how the simulation models heat escaping the physical component. In some implementations, this operation can directly inform the heat transfer analyzer 170 described in FIG. 1 and/or the boundary condition analysis at 245 in FIG. 2. While conduction through the solid material is primarily governed by the established thermophysical properties of the metal alloy, the heat lost to the surrounding environment through convection and radiation can be highly dependent on the specific manufacturing setup. At 340, the process 300 iteratively adjusts a convective heat transfer coefficient and a surface emissivity variable. For example, if the physical test was printed in an environment with forced shielding gas or localized cooling fans, the simulated convective heat transfer coefficient must be increased to reflect the accelerated cooling rate observed in the later stages of the empirical cooling curve. By separating the calibration of the heat input at 330 from the calibration of the cooling boundaries at 340, the process 300 can isolate specific thermodynamic behaviors and produce a comprehensive set of calibrated parameters.

Once the iterations at 330 and 340 achieve a predetermined degree of convergence where the simulated thermal history closely mirrors the empirical thermal history, the calibration process can conclude. In some implementations, the resulting calibrated parameters can then be saved and utilized by the PICPO framework to accurately process the full scale production build plan, facilitating high fidelity thermal predictions without requiring continuous sensor feedback during the actual manufacturing run.

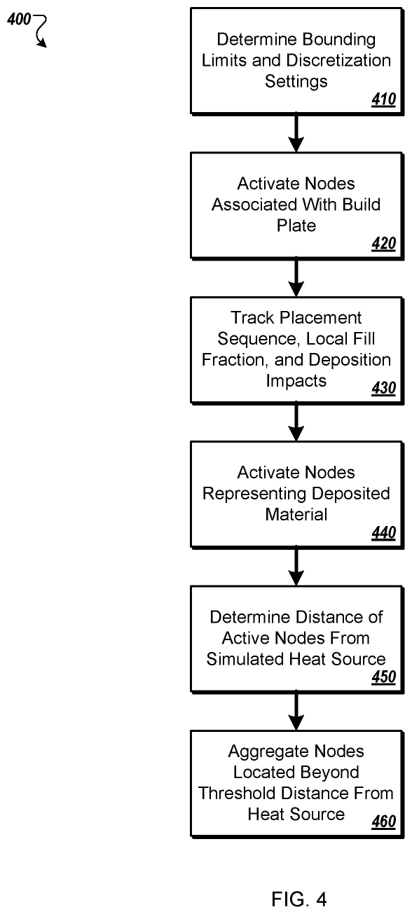

FIG. 4 illustrates a flow diagram of an exemplary process 400 for generating a dynamic nodal mesh and executing a birth and death activation strategy during an additive manufacturing simulation. In some implementations, the operations of the process 400 can be a detailed expansion of the coordinated operations described at 230 and 235 in FIG. 2. By executing the process 400, the print interpass cooling pause system 150 can efficiently construct and manage the virtual environment required to solve the transient thermal equations without overwhelming the available computational resources. Because transient thermal equations are highly nonlinear and require fine temporal resolution to maintain mathematical stability, the memory footprint and calculation times can easily exceed practical limits if the virtual environment is not rigorously controlled. By executing the process 400, the system dynamically balances high fidelity physical representation with computational economy.

At 410, the process 400 determines bounding limits and discretization settings. A processing module analyzes the time-resolved deposition history reconstructed in previous operations to establish a three-dimensional virtual envelope that substantially or completely encapsulates the planned component. For example, if the build plan dictates the fabrication of a hollow cylindrical pipe with a radius of ten centimeters and a height of fifty centimeters, the processing module can establish bounding limits that encompass that specific cylindrical volume, excluding surrounding void regions. Generating finite elements in areas where no material is expected to exist can consume unnecessary memory and slow down matrix assembly. Concurrently, the processing module can establish the discretization settings by defining the specific dimensions of the finite elements that will populate this volume. Using the bead geometry estimates generated during earlier phases, the processing module can calculate optimized physical distances between nodes, creating fine, tightly packed elements to capture steep, rapid thermal gradients directly in the weld zone and coarser, larger elements elsewhere in the structural body. This variable mesh density allows the model to prioritize mathematical precision exactly where the intense physical heat flux is occurring.

Following the establishment of the virtual envelope, at 420 the process 400 activates nodes associated with the build plate. In physical direct energy deposition systems, the component is welded directly onto a foundational substrate that acts as a massive thermal sink, heavily influencing the initial heat transfer dynamics. To accurately simulate this physical reality, the processing module can initialize a grid of active finite elements corresponding to the physical dimensions and thermophysical properties of this substrate before any simulated deposition begins. For example, if the physical printing process utilizes a thick carbon steel plate measuring one meter by one meter, the operation at 420 can populate the bottom of the virtual environment with corresponding steel nodes partly or fully participating in the thermal calculations from the first millisecond of the simulation. This initial active grid establishes the foundational boundary conditions for the physical print, allowing the processing module to calculate the rapid conductive heat transfer flowing out of the first deposited layers, through the thick metal plate, and into the physical machine table and clamping fixtures. Accurately modeling this initial thermal escape route provides the foundational baseline for predicting the temperature of all subsequent layers.

At 430, the process 400 tracks placement sequence, local fill fraction, and deposition impacts. Since molten metal deforms and overlaps upon deposition, a standard rigid grid may not accurately capture the true physical morphology of the deposited bead. To account for this, a deposition routine calculates how much of a given finite element is actually occupied by the deposited material. For example, if a programmed toolpath places a new weld bead directly adjacent to a previously deposited bead, the operation at 430 can calculate the overlapping physical impact and assign a local fill fraction, such as eighty percent or ninety percent, to the boundary nodes. This fractional assignment can help prevent the simulation from artificially overestimating the thermal mass of a given region. Because the physical cross section of the bead influences how quickly heat can conduct through that specific physical pathway, this continuous tracking can help build a comprehensive map of the true material density, localized porosity, and physical occupancy across the entire structural grid.

At 440, the process 400 activates nodes representing deposited material using a birth and death activation strategy. Prior to this step, the finite elements representing the unprinted component can be assigned near-zero stiffness and thermal conductivity multipliers, effectively removing them from the active thermal calculations without triggering matrix singularity errors in the mathematical solver. As the virtual clock advances and the simulated print head moves through the bounding limits, the processing module can activate the nodes at the coordinates corresponding to the active deposition history. For example, when the simulated toolpath reaches a specific coordinate at layer five, the operation at 440 can restore the actual thermal conductivity and heat capacity values to the nodes at that location, dynamically introducing new hot material into the transient thermal simulation just as the physical arc adds liquid metal to the real world part. This instantaneous restoration of properties seamlessly integrates the newly deposited mass into the ongoing conductive heat transfer equations.

As the simulation progresses and thousands of nodes are activated, at 450 the process 400 determines the distance of active nodes from the simulated heat source. In some implementations, a processing module can continuously or periodically calculate a physical vector distance between the center of the active heat input field, such as the Goldak double ellipsoid model established in previous steps, and the coordinates of the previously activated nodes. For example, the system can measure that a cluster of nodes representing a bead deposited on the first layer is currently forty centimeters away from the active melt pool on the twentieth layer. This spatial relationship analysis can be periodically or continuously updated as the simulated print head travels along the toolpath. Because the heat source is continuously in motion, the thermal gradients are highly dynamic. A node located in the immediate vicinity of the active arc experiences rapid, extreme temperature fluctuations, while nodes situated further away experience only gradual, uniform warming or cooling. The spatial relationship analysis performed at 450 identifies these distinct thermal zones, tagging specific coordinate clusters based on their relative proximity to the intense thermal energy injected by the active deposition event.

At 460, the process 400 aggregates nodes located beyond a threshold distance from the heat source. Calculating the heat transfer between tens of thousands of microscopic finite elements can require immense computational power. However, nodes located far away from the active welding zone can experience very slow, uniform temperature changes. To improve or optimize processing speed, the process 400 can dynamically combine these distant nodes into larger aggregated masses. For example, if the threshold distance is set to ten centimeters, the operation at 460 can identify a block of sixty four small individual elements located fifteen centimeters away from the active arc. The processing module can consolidate these sixty-four individual elements into a coarsened element having an equivalent thermal mass and boundary surface area. By lumping these distant nodes together, the processing module preserves the overall thermal energy and physical geometry of the component while vastly reducing the complexity of the nodal matrix. In some implementations, dynamic aggregation can drastically reduce the number of equations the solver must process at each time step, allowing the overall framework to calculate entire build plans rapidly, with fewer processor, memory, and communication resources, and with reduced power consumption.

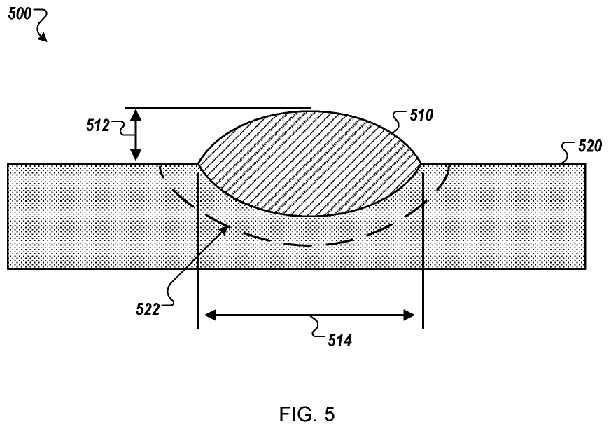

FIG. 5 illustrates a schematic cross sectional view 500 of a deposited weld bead 510 physically bonded to a substrate 520 during an additive manufacturing process. The geometric parameters depicted in FIG. 5 can be used for execution of the computational operations described in FIG. 2 and FIG. 4. In some implementations, the physical dimensions of the weld bead 510 can inform the discretization settings of the nodal mesh and establish the physical boundaries required for the volumetric heat input field. In some implementations, by accurately predicting these cross sectional geometries prior to actual deposition, the PICPO framework can dynamically scale the virtual environment to reflect the physical realities of the direct energy deposition process.

The weld bead 510 represents newly deposited molten metal that has solidified upon the substrate 520. Depending on the current progression of the simulated build plan, the substrate 520 can represent the initial foundational build plate or a previously deposited layer of the component itself. The physical interaction between the weld bead 510 and the substrate 520 can dictate the primary conductive heat transfer pathways. When the extreme thermal energy of the electric arc liquefies the deposition wire to form the weld bead 510, that thermal energy immediately begins conducting rapidly into the cooler mass of the substrate 520. Accurately modeling the physical contact area between these two distinct regions can improve the ability of the transient thermal solver to calculate an accurate rate of thermal dissipation.

A nominal bead height 512, sometimes denoted mathematically as h, represents the maximum vertical elevation of the deposited weld bead 510 measured from the original surface plane of the substrate 520. In some implementations, a processing module can utilize the predicted or measured nominal bead height 512 to establish the vertical nodal step sizes, or z-axis increments, during the mesh generation operations described in FIG. 4. For example, if the deposition parameters dictate a thick, voluminous deposition resulting in a large nominal bead height 512, the processing module can automatically increase the vertical distance between the finite element nodes in the z direction. In some implementations, such dynamic scaling can help prevent the creation of excessively dense nodal grids that could needlessly consume computational resources, while still providing sufficient mathematical resolution to capture the vertical thermal gradients.

A nominal bead width 514, sometimes denoted mathematically as w, represents the maximum transverse span of the deposited weld bead 510 across the surface of the substrate 520. In some implementations, the processing module can utilize the nominal bead width 514 to determine the horizontal nodal step sizes, establishing the x-axis and y-axis increments for the structural grid. Furthermore, the nominal bead width 514 can correlate to the molten pool width variable, denoted as b, within the double ellipsoid heat source model discussed in FIG. 2. For example, if a machine operator programs a slow tool travel speed combined with a high wire feed rate, the resulting physical molten pool will generally widen significantly, producing a large nominal bead width 514. The processing module can calculate this expanded dimension and correspondingly widen both the spacing of the finite element mesh and the transverse axis of the virtual volumetric heat input field, closely mimicking the physical spread of the thermal energy.

A penetration boundary 522 illustrates the depth to which the intense heat of the arc melts into the underlying substrate 520, as well as the surrounding heat affected zone. The physical fusion process is not merely a surface adhesion; the liquid metal of the weld bead 510 can aggressively remelt a portion of the solid substrate 520 to form a deep, integral metallurgical bond. The lowest extreme of the penetration boundary 522 can correlate directly to the molten pool depth variable, denoted as a, within the volumetric heat source model. In some examples, the region immediately outside the remelted zone but still within the penetration boundary 522 can experience extreme thermal cycling that can induce severe microstructural phase transformations. In some implementations, accurately mapping the extent of the penetration boundary 522 can improve the ability of the processing module to identify the specific finite element nodes that may be subjected to temperatures exceeding predetermined metallurgical thresholds, which can be a factor in triggering calculation of dynamic interpass cooling pauses.

Because these geometric parameters vary drastically based on the specific machine settings, the process does not rely on static, idealized parabolic shapes. Instead, as introduced in the description of FIG. 2, a suite of regression based equations can be used to predict the nominal bead height 512, the nominal bead width 514, and/or the penetration boundary 522 dynamically. These regression models can evaluate the commanded arc power, the wire feed speed, and/or the travel speed at some, most, or every individual line of the parsed numeric array. By continuously recalculating the dimensions of the weld bead 510 for multiple or all individual deposition events across a portion of or the entire build volume, the system can maintain a highly accurate, substantially constantly adapting virtual representation of the physical component, facilitating precise thermal predictions and improved or optimized cooling strategies.

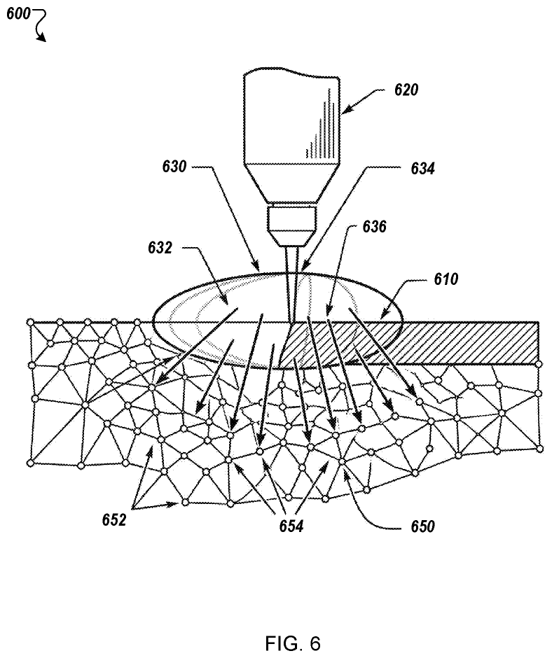

FIG. 6 illustrates a conceptual schematic cross sectional view of a direct energy deposition environment 600 during an active deposition event. The operations and physical interactions depicted in FIG. 6 can provide a visual representation of the mathematical heat flux mapping described in previous figures, specifically illustrating the intersection between the example dynamic nodal mesh generated during the process 400 of FIG. 4 and the example volumetric heat input field constructed at 240 in FIG. 2. By modeling this specific interaction, the example print interpass cooling pause system 150 of FIG. 1 can more accurately simulate the transfer of thermal energy from the physical welding equipment into the virtual component.

In the direct energy deposition environment 600, a physical or simulated welding head 620 (e.g., of the example DED system 190) travels along a predetermined toolpath, depositing a molten weld bead 630 onto a welding substrate 610. Depending on the current stage of the manufacturing process, the welding substrate 610 can represent a foundational metal build plate or a solid layer of previously deposited material. To accurately calculate the transient thermal conduction through these solid bodies, the physical volume of the welding substrate 610 and the weld bead 630 is discretized computationally into a finite element analysis lattice 650. This lattice is composed of multiple individual finite element nodes 652 connected to form a structural grid. As the welding head 620 progresses, the nodes 652 representing the newly deposited weld bead 630 are mathematically activated using the birth and death strategy previously described, introducing their specific thermophysical properties into the simulation.

As the welding head 620 deposits material, it simultaneously introduces substantial heat energy 636 into the welding substrate 610. To computationally replicate this complex physical phenomenon, the processing module applies a volumetric heat source model, such as a Goldak double ellipsoid model. This mathematical geometry is divided into two distinct regions to capture the asymmetric nature of a moving heat source. A Goldak fore semi-ellipsoid 632 represents the front half of the heat source model. The Goldak fore ellipsoid 632 is typically modeled with a shorter longitudinal axis because the welding head 620 is continuously advancing into cold, unheated material, resulting in a steeply compressed thermal gradient at the leading edge of the melt pool. Conversely, a Goldak aft semi-ellipsoid 634 represents the rear half of the heat source model. The Goldak aft ellipsoid 634 is modeled with an elongated longitudinal axis to accurately reflect the trailing tail of hot liquid metal that slowly solidifies behind the active arc.

A heat flux mapping represented by arrows 654 illustrates the mathematical assignment of thermal energy from the volumetric heat source model directly to the individual finite element nodes 652. The processing module periodically or continuously calculates the physical coordinate distance between the geometric center of the welding head 620 and each specific node 652 residing within the volumetric boundaries of the Goldak fore ellipsoid 632 and the Goldak aft ellipsoid 634. Using, for example, a three dimensional Gaussian distribution equation, the processing module assigns a specific heat flux value to the nodes based on the nodes' relative locations. For example, a node located directly beneath the center of the welding head 620 can receive a maximum heat flux assignment, representing the extreme peak temperatures of the plasma arc. Conversely, a node located near the outer boundary of the Goldak aft ellipsoid 634 can receive a significantly lower heat flux assignment, representing the cooler edges of the solidifying weld puddle.

As the virtual clock advances, the entire double ellipsoid model moves across the finite element analysis lattice 650 in synchronized coordination with the programmed toolpath of the welding head 620. As the model translates through the virtual space, the heat flux mapping 654 is dynamically recalculated at some or every one of the temporal sub steps. New finite element nodes 652 entering the boundary of the Goldak fore ellipsoid 632 can experience a rapid spike in applied heat energy 636, while nodes exiting the boundary of the Goldak aft ellipsoid 634 can be transitioned into a cooling phase where boundary condition convective and radiative losses dominate. This dynamic recalculation of the heat flux mapping 654 enables the predictive framework to accurately track localized thermal accumulation, ultimately facilitating the calculation of precise interpass cooling pauses when specific nodal temperatures exceed predetermined metallurgical thresholds.

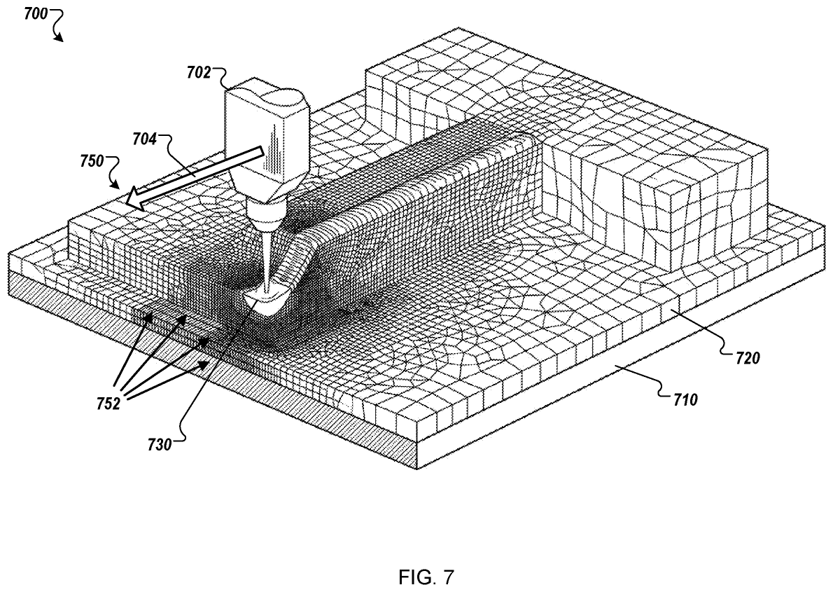

FIG. 7 illustrates a conceptual schematic perspective view of a direct energy deposition environment 700 during an active virtual simulation. The perspective view provided in FIG. 7 visually synthesizes the computational mesh generation techniques and dynamic aggregation strategies detailed in the process 400 of FIG. 4. By rendering the finite element analysis lattice 750 in three dimensions, FIG. 7 can represent how a process can strategically allocate mathematical resolution to capture complex thermal gradients while simultaneously conserving computational resources across the broader structural domain. Because additive manufacturing involves a massive number of localized melting events over a span of hours or days, calculating the thermodynamic state of every microscopic particle simultaneously can quickly overwhelm the memory allocation of standard workstations. The perspective view provided in FIG. 7 visually synthesizes how the system overcomes this computational bottleneck.

Within the direct energy deposition environment 700, a virtual representation of a welding head 702 (e.g., of the example DED system 190) is depicted traveling along a programmed toolpath 704. As the welding head 702 advances, it deposits a new weld bead 730 onto a previously deposited structure 720. The previously deposited structure 720 represents the accumulated layers of material that have already been computationally activated through the birth and death strategy during earlier stages of the simulation. This entire virtual component is supported by a welding substrate 710, which acts as the foundational thermal sink for the downward conduction of heat energy. In a physical setting, the welding substrate 710 can correlate to the heavy steel or aluminum build plate secured to the machine table. This foundational thermal sink possesses a massive thermal inertia compared to the thin layers being deposited. When the initial layers of the previously deposited structure 720 are applied, the heat energy conducts rapidly downwards into the cold mass of the welding substrate 710. As the component grows taller, this conductive pathway lengthens, fundamentally altering the thermal dynamics. The virtual representation continuously tracks these physical changes to calculate accurate cooling rates.

To calculate the transient thermal evolution of this complex assembly, the process discretizes the continuous volumes of the welding substrate 710, the previously deposited structure 720, and the active weld bead 730 into the comprehensive finite element analysis lattice 750. The finite element analysis lattice 750 is composed of multiple individual finite element nodes 752 connected to form a contiguous geometric grid. The mathematical solver utilizes strict continuity between these adjoining elements to accurately calculate the flow of thermal energy from one microscopic sector to the next. The specific spatial distribution and sizing of the finite element nodes 752 depicted in FIG. 7 provide a direct visualization of the variable mesh density and distance based aggregation operations.

In the immediate vicinity of the active welding head 702 and the newly formed weld bead 730, the finite element analysis lattice 750 exhibits an extremely dense, highly refined structural grid. The finite element nodes 752 in this localized region are packed closely together, creating microscopic geometric subdivisions. This high level of mathematical resolution is used to accurately capture the severe, highly localized thermal gradients generated by the moving heat source. Because the volumetric heat input field, such as the Goldak double ellipsoid model, injects substantial thermal energy into a very small spatial volume, the process can utilize these tightly clustered nodes to help prevent the simulated temperatures from mathematically blurring or artificially dissipating too rapidly. If the finite element nodes 752 in this active region were too far apart, the mathematical solver might miss some of the extreme peak temperatures, potentially leading to an underestimation of the localized heat accumulation. By maintaining tight geometric subdivisions precisely where the plasma arc meets the metal, the process accurately tracks the molten pool and the immediate surrounding heat affected zone.

Conversely, as the physical distance from the active welding head 702 increases, the density of the finite element analysis lattice 750 decreases substantially. In regions located far from the active heat flux, such as the outer corners of the welding substrate 710 or the distal ends of the previously deposited structure 720, the process can dynamically execute the aggregation routines to consolidate the finite element nodes 752 into relatively larger, coarsened blocks. Because the material in these distant regions can experience only very slow, gradual, and uniform temperature changes dominated by ambient convective cooling, high resolution calculation can be computationally wasteful. The process can amalgamate these distant regions into larger consolidated elements having an equivalent thermal mass and an equivalent exterior surface area. By preserving the total volume and surface area during this consolidation, the process can maintain the physical integrity of the thermal calculations. The distant regions can still accurately reflect ambient environmental losses without forcing the processor to solve thousands of redundant equations for material that has already reached a steady thermal state.

Beyond internal conduction handled by the finite element analysis lattice 750, the perspective view of the direct energy deposition environment 700 also highlights the continuously evolving exterior geometry of the physical component. As the welding head 702 adds the new weld bead 730 to the previously deposited structure 720, the total exposed surface area of the component changes at every time step. The process continuously identifies which specific finite element nodes 752 currently reside on the exterior boundary of the overall virtual volume. Accurately identifying these surface boundary nodes is critical, as convective cooling into the ambient atmosphere and radiative heat loss only occur across these exterior faces. When a new layer is deposited, nodes that were previously on the surface become buried and transition to pure conductive heat transfer, while the newly activated nodes take over the boundary condition cooling calculations. For example, if the programmed toolpath 704 dictates the construction of a hollow vertical cylinder, the uppermost exposed ring of the previously deposited structure 720 will rapidly lose heat to the surrounding atmospheric air. However, the moment the welding head 702 deposits the new weld bead 730 on top of that ring, those specific surface boundary nodes are quickly covered. The system can then revoke their convective boundary status and transition them to internal conductive nodes to promote mathematical fidelity.

Furthermore, the three dimensional expanse of the previously deposited structure 720 can help illustrate the capacity of the process to manage localized interpass temperatures during the manufacture of large parts. Rather than evaluating the entire component as a single thermal entity, the process can spatially subdivide the previously deposited structure 720 into multiple distinct thermal zones. For instance, if a large component features both a thick, massive section and a thin, delicate wall, the thin wall will generally retain heat differently than in thicker sections. The dense mass of the thick sections can act as an internal heat sink, drawing energy away from the surface, while the thin wall lacks the internal volume to dissipate the extreme thermal energy quickly. Without spatial subdivision, the thin wall might overheat and structurally collapse before the thicker sections even reach a critical temperature. By evaluating localized interpass temperatures for each distinct thermal zone, the process can determine highly targeted dynamic pause times. The process can determine and apply a specific pause duration to a first thermal zone that has exceeded a target threshold, while simultaneously permitting continuous deposition in a second thermal zone that has sufficiently cooled. This spatial subdivision facilitates optimized manufacturing schedules, preventing unnecessary machine idling while still protecting the structural integrity of complex geometries.

Additionally, the perspective view of the direct energy deposition environment 700 can conceptualize the capacity of the process to coordinate simultaneous thermal inputs from multiple active deposition heads. In advanced manufacturing setups, two or more physical print heads may operate concurrently on the same welding substrate 710 to accelerate production. To simulate this physical reality, the process can introduce a second virtual representation of a welding head alongside the primary welding head 702. The process can calculate independent volumetric heat input fields for each active head, projecting simultaneous thermal energy into the finite element analysis lattice 750. When these multiple deposition heads operate in close proximity, their respective thermal gradients can overlap and compound, creating localized zones of extreme heat accumulation that a single heat source model may fail to predict. The process can periodically or continuously evaluate the constructive interference of these simultaneous heat fluxes, mapping the combined thermal burden onto the finite element nodes 752. Because the process can track the independent toolpaths of each active head against a unified virtual clock, the process can determine highly complex, multi head dynamic pause strategies. For example, if the combined heat input of two heads approaches a critical metallurgical limit within a specific sector of the previously deposited structure 720, the process can modify the G-code to command one head to pause or retreat while permitting the other head to continue depositing material in a cooler, separate thermal zone. This concurrent simulation capability can help prevent catastrophic overheating in high deposition rate environments while boosting or maximizing the utilization of the available manufacturing hardware.

This dynamic variable meshing and evaluation strategy can be substantially transient. For example, as the virtual clock advances and the welding head 702 translates further along the toolpath 704, the dense pocket of highly refined finite element nodes 752 moves in synchronized coordination with it. The process can dynamically refine the mesh of the lattice 750 immediately ahead of the advancing weld bead 730 while also aggregating or coarsening the mesh left behind in the cooling wake. This continuous cycle of localized refinement and subsequent coarsening acts as a localized computational wave that travels continuously through the virtual component, closely mimicking the localized physical heating and cooling cycle of the manufacturing process itself. By periodically or continuously adapting the finite element analysis lattice 750 to prioritize mathematical precision where the physics are most active and dynamic, the process can determine highly accurate interpass temperature predictions across large, industrial scale components without requiring high capacity computing hardware.

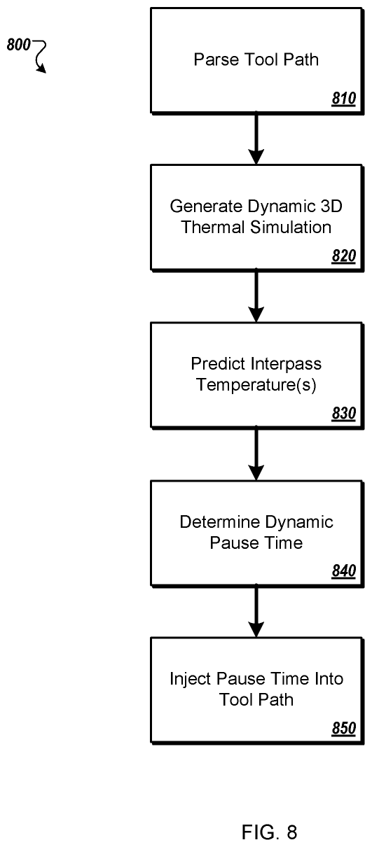

FIG. 8 illustrates a flow diagram of an exemplary process 800 for modifying or optimizing a direct energy deposition build plan. In some implementations, the operations depicted in FIG. 8 can represent the overarching process executed by the example print interpass cooling pause system 150 of FIG. 1, and/or can summarize the comprehensive workflows detailed across the preceding figures.

At 810, the process 800 includes parsing a toolpath having multiple deposition events for fabricating a component using direct energy deposition additive manufacturing process. For example, during this operation, the print interpass cooling pause system 150 can ingest an initial build plan, such as a standard G-code file generated by a standard slicing utility. The print interpass cooling pause system 150 can break this file down line by line, extracting the explicit spatial coordinates, commanded travel speeds, wire feed rates, and/or active laser or arc power states for individual lines of instruction. By executing this parsing operation, the print interpass cooling pause system 150 can translate the raw alphanumeric text into a structured, time resolved numeric array that the subsequent physical modeling operations can interpret and manipulate.

At 820, the process 800 includes generating a dynamic three dimensional thermal simulation of a print process based on the extracted print parameters, the machine instructions, and material properties. For example, the print interpass cooling pause system 150 can apply a volumetric heat input model to a dynamic nodal mesh based on the parsed toolpath. This operation can synthesize the complex mesh generation, element activation, and/or double ellipsoid heat flux mapping techniques discussed in the descriptions of FIG. 4, FIG. 6, and FIG. 7. The print interpass cooling pause system 150 can utilize the structured numeric array to step a virtual clock forward, depositing virtual material and injecting massive amounts of calculated thermal energy into a transient finite element environment. By generating a dynamic three dimensional thermal simulation of the component by applying a volumetric heat input model to a dynamic nodal mesh based on the parsed toolpath, the print interpass cooling pause system 150 can accurately reconstruct the thermodynamic physics that the physical component is predicted to experience during actual manufacturing.

At 830, the process 800 includes predicting an interpass temperature for at least one deposited layer based on the dynamic three dimensional thermal simulation. For example, as the virtual simulation progresses, the print interpass cooling pause system 150 can continuously evaluate the thermal state of the solid material located immediately ahead of the advancing virtual heat source. Rather than relying on simple analytical estimates or broad part wide averages, the print interpass cooling pause system 150 can extract the predicted temperature values from the finite element nodes residing directly beneath the impending deposition coordinate. By predicting an interpass temperature for at least one deposition event of the multiple deposition events based on the dynamic three dimensional thermal simulation, the print interpass cooling pause system 150 can accurately identify localized hot spots and/or thermal accumulation zones that may otherwise lead to structural failure and/or poor metallurgical quality in the physical world.

At 840, the process 800 includes determining a dynamic pause time based on a comparison between the predicted interpass temperature and a predetermined threshold temperature. For example, once a localized interpass temperature is predicted, the print interpass cooling pause system 150 can compare that specific value against a predetermined metallurgical limit established for the specific metal alloy being deposited. If the predicted interpass temperature exceeds the predetermined threshold temperature, the print interpass cooling pause system 150 can calculate the exact duration of time required for that specific localized zone to cool back down to an acceptable level via simulated convective and radiative heat transfer. By determining a dynamic pause time based on a comparison between the predicted interpass temperature and a predetermined threshold temperature, the print interpass cooling pause system 150 can calculate an optimized wait period tailored specifically to the transient thermal state of that exact location on the component.

At 850, the process 800 includes modifying the tool path program to inject the dynamic pause time into the machine instructions prior to execution of the tool path. For example, the print interpass cooling pause system 150 can return to the originally parsed alphanumeric instructions and insert one or more new machine commands, such as a specific dwell code, directly before the deposition event that triggered the cooling calculation. The duration of this newly inserted dwell command can correspond accurately to the cooling duration calculated in the previous step. In some implementations, by injecting the dynamic pause time into the toolpath to generate a modified toolpath, the print interpass cooling pause system 150 can output an improved or highly optimized, ready-to-print file. This modified toolpath can facilitate substantially continuous, automated manufacturing that inherently respects the complex thermodynamic limits of the material, preventing overheating without requiring the physical machine to utilize closed loop feedback sensors.

In some implementations, generating the dynamic three dimensional thermal simulation can include generating a nodal mesh over a build volume and activating nodes within the nodal mesh using an element birth and death activation strategy based on the machine instructions. For example, as described in the context of FIG. 4, the print interpass cooling pause system 150 can utilize the parsed toolpath to assign actual thermal properties to finite element nodes corresponding to the newly deposited weld bead at the exact time the simulated print head passes over that specific coordinate.

In some implementations, generating the nodal mesh can include aggregating multiple nodes located beyond a threshold distance from a simulated deposition heat source into an aggregated mass to reduce a computational burden of the dynamic three dimensional thermal simulation. For example, as illustrated in FIG. 7, the print interpass cooling pause system 150 can identify finite element nodes located far from the active heat flux and dynamically consolidate those distant nodes into larger, coarsened blocks having an equivalent thermal mass.

In some implementations, the process can determine a nominal bead height and a nominal bead width for the deposited layer using regression based equations that account for the material properties and one or more heat input effects. For example, as discussed with reference to FIG. 5, the print interpass cooling pause system 150 can scale the distance between the finite element nodes according to a predicted cross sectional geometry of the weld bead, scaling the virtual environment to accurately reflect the physical spread of the thermal energy without relying on static parabolic shape assumptions.

In some implementations, the process can construct a heat input field using a double ellipsoid model and applies the heat input field to the dynamic three dimensional thermal simulation. For example, as visually depicted in FIG. 6, applied heat energy can be mathematically mapped into a Goldak fore ellipsoid representing a compressed thermal gradient at the leading edge of a melt pool, and a Goldak aft ellipsoid representing an elongated trailing tail of slowly solidifying liquid metal.

In some implementations, the process 800 can adjust environmental parameters within the dynamic three dimensional thermal simulation to account for a forced flow cooling applied during the direct energy deposition additive manufacturing process. For example, as established during the calibration process of FIG. 3, the print interpass cooling pause system 150 can modify a convective heat transfer coefficient applied to exterior boundary nodes to accurately reflect the accelerated cooling rate provided by localized cooling fans or active shielding gas utilized in the physical manufacturing environment.

In some implementations, the tool path program can include machine instructions configured to control simultaneous operation of multiple print heads, and the dynamic three dimensional thermal simulation coordinates heat input from the multiple print heads. For example, as described in the context of massive components in FIG. 7, the process 800 can be configured to track multiple independent toolpaths for deposition events, periodically or continuously evaluating constructive interference and overlapping thermal gradients to prevent catastrophic localized overheating when multiple physical heat sources operate in close proximity.

In some implementations, the process 800 can subdivide the deposited layer into multiple thermal zones, predict localized interpass temperatures for each thermal zone of the multiple thermal zones, and/or apply the dynamic pause time to a first thermal zone of the multiple thermal zones while permitting deposition in a second thermal zone of the multiple thermal zones. For example, the print interpass cooling pause system 150 can evaluate thin wall structures independently from massive thick sections, triggering localized dwell commands to prevent the thin sections from accumulating excess heat and collapsing while allowing the hardware to continue depositing material in thicker, cooler regions.

In some implementations, modifying the tool path program to inject the dynamic pause time can be performed as a post processing step such that the modified tool path program is configured to be performed substantially without reliance on real-time sensor-based feedback loops. For example, as outlined in the system overview of FIG. 1, the print interpass cooling pause system 150 can act as an offline simulation engine to calculate all necessary thermal management interventions prior to printing, outputting a static file that the physical hardware executes deterministically without checking optical pyrometers and/or infrared cameras during the print sequence.

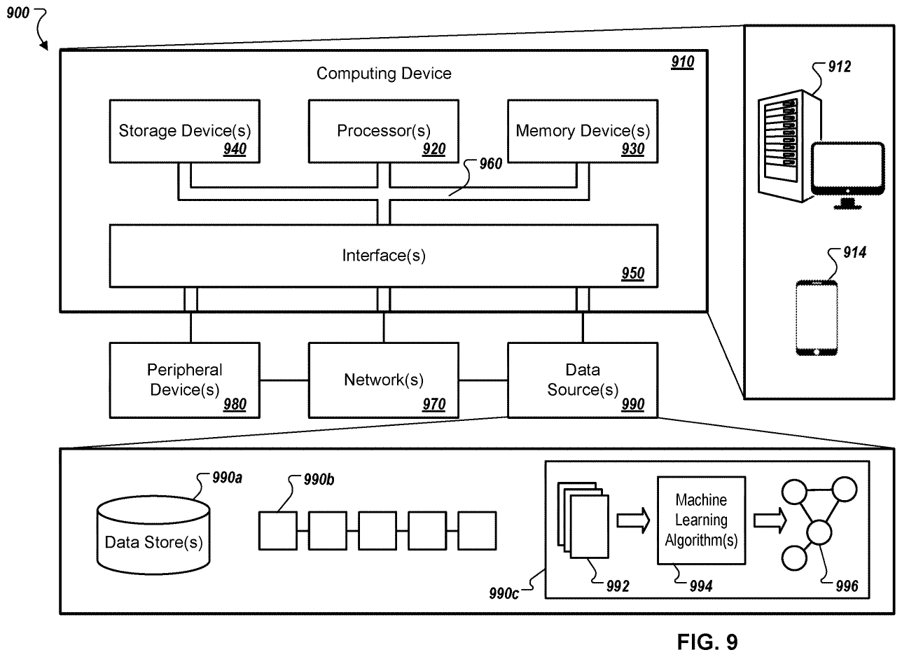

FIG. 9 is a schematic diagram that shows an example of a computing system 900 that can be used to implement the techniques described herein. The computing system 900 includes one or more computing devices (e.g., computing device 910), which can be in wired and/or wireless communication with various peripheral device(s) 980, data source(s) 990, and/or other computing devices (e.g., over network(s) 970). The computing device 910 can represent various forms of stationary computers 912 (e.g., workstations, kiosks, servers, mainframes, edge computing devices, quantum computers, etc.) and mobile computers 914 (e.g., laptops, tablets, mobile phones, personal digital assistants, wearable devices, etc.). In some implementations, the computing device 910 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 910, and an entire system can be made up of multiple devices communicating with each other. For example, the computing device 910 can be part of a computing system that includes a network of computing devices, such as a cloud-based computing system, a computing system in an internal network, or a computing system in another sort of shared network. Processors of the computing device (910) and other computing devices of a computing system can be optimized for different types of operations, secure computing tasks, etc. The components shown herein, and their functions, are meant to be examples, and are not meant to limit implementations of the technology described and/or claimed in this document.

The computing device 910 includes processor(s) 920, memory device(s) 930, storage device(s) 940, and interface(s) 950. Each of the processor(s) 920, the memory device(s) 930, the storage device(s) 940, and the interface(s) 950 are interconnected using a system bus 960. The processor(s) 920 are capable of processing instructions for execution within the computing device 910, and can include one or more single-threaded and/or multi-threaded processors. The processor(s) 920 are capable of processing instructions stored in the memory device(s) 930 and/or on the storage device(s) 940. The memory device(s) 930 can store data within the computing device 910, and can include one or more computer-readable media, volatile memory units, and/or non-volatile memory units. The storage device(s) 940 can provide mass storage for the computing device 910, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 950 can include various communications interfaces (e.g., USB, Near-Field Communication (NFC), Bluetooth, WiFi, Ethernet, wireless Ethernet, etc.) that can be coupled to the network(s) 970, peripheral device(s) 980, and/or data source(s) 990 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 950 can include a control interface that receives commands from an input device (e.g., operated by a user) and converts the commands for submission to the processors 920. The interface(s) 950 can include a display interface that includes circuitry for driving a display to present visual information to a user. The interface(s) 950 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 970 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 910 can communicate with the peripheral device(s) 980, the data source(s) 990, and/or other computing devices over the network(s) 970. In some implementations, the computing device 910 can directly communicate with the peripheral device(s) 980, the data source(s), and/or other computing devices.

The peripheral device(s) 980 can provide input/output operations for the computing device 910. Input devices (e.g., keyboards, pointing devices, touchscreens, microphones, cameras, scanners, sensors, etc.) can provide input to the computing device 910 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 910 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 990 can provide data for use by the computing device 910, and/or can maintain data that has been generated by the computing device 910 and/or other devices (e.g., data collected from sensor devices, data aggregated from various different data repositories, etc.). In some implementations, one or more data sources can be hosted by the computing device 910 (e.g., using the storage device(s) 940). In some implementations, one or more data sources can be hosted by a different computing device. Data can be provided by the data source(s) 990 in response to a request for data from the computing device 910 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 990a. The database(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in the database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 990b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 990c. The machine learning system(s) 990c, for example, can be used to analyze data from various sources (e.g., data provided by the computing device 910, data from the data store(s) 990a, data from the blockchain(s) 990b, and/or data from other data sources), to identify patterns in the data, and to draw inferences from the data patterns. In general, training data 992 can be provided to one or more machine learning algorithms 994, and the machine learning algorithm(s) can generate a machine learning model 996. Execution of the machine learning algorithm(s) can be performed by the computing device 910, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer- or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A system for managing interpass cooling during a direct energy deposition additive manufacturing process, the system comprising:
a processor; and a memory storing instructions that, when executed by the processor, cause the processor to perform operations comprising:
parsing a tool path program to extract print parameters and machine instructions for the direct energy deposition additive manufacturing process;
generating a dynamic three dimensional thermal simulation of a print process based on the extracted print parameters, the machine instructions, and material properties;
predicting an interpass temperature for a deposited layer based on the dynamic three dimensional thermal simulation;
determining a dynamic pause time by comparing the predicted interpass temperature to a target interpass temperature; and
modifying the tool path program to inject the dynamic pause time into the machine instructions prior to execution of the tool path program.

2. The system of claim 1, wherein the instructions that cause the processor to generate the dynamic three dimensional thermal simulation further cause the processor to generate a nodal mesh over a build volume and activate nodes within the nodal mesh using an element birth and death activation strategy based on the machine instructions.

3. The system of claim 2, wherein the instructions that cause the processor to generate the nodal mesh further cause the processor to aggregate a plurality of nodes located beyond a threshold distance from a heat source into an aggregated mass to reduce a computational burden of the dynamic three dimensional thermal simulation.

4. The system of claim 1, wherein the operations further comprise constructing a heat input field using a double ellipsoid model, and applying the heat input field to the dynamic three dimensional thermal simulation.

5. The system of claim 1, wherein the operations further comprise adjusting environmental parameters within the dynamic three dimensional thermal simulation to account for a forced flow cooling system.

6. The system of claim 1, wherein the operations further comprise:
subdividing the deposited layer into a plurality of thermal zones;
predicting localized interpass temperatures for each thermal zone of the plurality of thermal zones; and
applying the dynamic pause time to a first thermal zone of the plurality of thermal zones while permitting deposition in a second thermal zone of the plurality of thermal zones.

7. A non-transitory computer readable storage medium having instructions stored thereon that, when executed by a processor, cause the processor to perform operations comprising:
parsing a tool path program to extract print parameters and machine instructions for a direct energy deposition additive manufacturing process;
generating a dynamic three dimensional thermal simulation of a print process based on the extracted print parameters, the machine instructions, and material properties;
predicting an interpass temperature for a deposited layer based on the dynamic three dimensional thermal simulation;
determining a dynamic pause time by comparing the predicted interpass temperature to a target interpass temperature; and
modifying the tool path program to inject the dynamic pause time into the machine instructions prior to execution of the tool path program.

8. The non-transitory computer readable storage medium of claim 7, wherein the instructions that cause the processor to generate the dynamic three dimensional thermal simulation further cause the processor to generate a nodal mesh over a build volume and activate nodes within the nodal mesh using an element birth and death activation strategy based on the machine instructions.

9. The non-transitory computer readable storage medium of claim 8, wherein the instructions that cause the processor to generate the nodal mesh further cause the processor to aggregate a plurality of nodes located beyond a threshold distance from a heat source into an aggregated mass to reduce a computational burden of the dynamic three dimensional thermal simulation.

10. The non-transitory computer readable storage medium of claim 7, wherein the operations further comprise:
constructing a heat input field using a double ellipsoid model; and
applying the heat input field to the dynamic three dimensional thermal simulation.

11. The non-transitory computer readable storage medium of claim 7, wherein the operations further comprise:
subdividing the deposited layer into a plurality of thermal zones;
predicting localized interpass temperatures for each thermal zone of the plurality of thermal zones; and
applying the dynamic pause time to a first thermal zone of the plurality of thermal zones while permitting deposition in a second thermal zone of the plurality of thermal zones.

12. A computer implemented method for managing interpass cooling during a direct energy deposition additive manufacturing process, the method comprising:
parsing a tool path program to extract print parameters and machine instructions for the direct energy deposition additive manufacturing process;
generating a dynamic three dimensional thermal simulation of a print process based on the extracted print parameters, the machine instructions, and material properties;
predicting an interpass temperature for a deposited layer based on the dynamic three dimensional thermal simulation;
determining a dynamic pause time by comparing the predicted interpass temperature to a target interpass temperature; and
modifying the tool path program to inject the dynamic pause time into the machine instructions prior to execution of the tool path program.

13. The method of claim 12, wherein generating the dynamic three dimensional thermal simulation comprises generating a nodal mesh over a build volume and activating nodes within the nodal mesh using an element birth and death activation strategy based on the machine instructions.

14. The method of claim 13, wherein generating the nodal mesh comprises aggregating a plurality of nodes located beyond a threshold distance from a simulated deposition heat source into an aggregated mass to reduce a computational burden of the dynamic three dimensional thermal simulation.

15. The method of claim 12, further comprising determining a nominal bead height and a nominal bead width for the deposited layer using regression based equations that account for the material properties and one or more heat input effects.

16. The method of claim 12, further comprising:
constructing a heat input field using a double ellipsoid model; and
applying the heat input field to the dynamic three dimensional thermal simulation.

17. The method of claim 12, further comprising adjusting environmental parameters within the dynamic three dimensional thermal simulation to account for a forced flow cooling applied during the direct energy deposition additive manufacturing process.

18. The method of claim 12, wherein the tool path program comprises machine instructions configured to control simultaneous operation of a plurality of print heads, and wherein the dynamic three dimensional thermal simulation coordinates heat input from the plurality of print heads.

19. The method of claim 12, further comprising:
subdividing the deposited layer into a plurality of thermal zones;
predicting localized interpass temperatures for each thermal zone of the plurality of thermal zones; and
applying the dynamic pause time to a first thermal zone of the plurality of thermal zones while permitting deposition in a second thermal zone of the plurality of thermal zones.

20. The method of claim 12, wherein modifying the tool path program to inject the dynamic pause time is performed as a post processing step such that the modified tool path program is configured to be performed without reliance on real time sensor based feedback loops.
